(19) United States
(12) Patent Application Publication
(10) Pub. No.: US 2015/0143291 A1
(43) Pub. Date: May 21, 2015

(54) SYSTEM AND METHOD FOR CONTROLLING DATA ITEMS DISPLAYED ON A USER INTERFACE

(71) Applicant: Tencent Technology (Shenzhen) Company Limited, Shenzhen (CN)

(72) Inventor: Wen ZHA, Shenzhen (CN)

(21) Appl. No.: 14/327,194

(22) Filed: Jul. 9, 2014

Related U.S. Application Data
(63) Continuation of application No. PCT/CN2014/075919, filed on Apr. 22, 2014.

(30) Foreign Application Priority Data
Nov. 21, 2013 (CN) 201310593980.6

(51) Int. Cl. G06F 3/0488; G06F 3/0482

(52) U.S. Cl. CPC G06F 3/0488; G06F 3/0482
USPC 715/810

(57) ABSTRACT

The present application discloses a method for controlling data items displayed on a touch-sensitive display of a computing device. The method includes, at the computing device, displaying a plurality of data items on a graphical user interface of the touch display, and detecting a sequence of finger gestures on the touch display. The sequence of finger gestures further includes a finger down gesture immediately followed by a finger moving gesture immediately followed by a finger up gesture. The method further includes in accordance with a determination that the sequence of finger gestures satisfy predefined conditions, identifying a set of the plurality of data items as being associated with the sequence of finger gestures and displaying a plurality of operations on the touch display, wherein the plurality of operations are determined at least in part based on an attribute of the identified set of data items.

### RELATED APPLICATION

This application is a continuation application of PCT Patent Application No. PCT/CN2014/075919, entitled “SYSTEM AND METHOD FOR CONTROLLING DATA ITEMS DISPLAYED ON A USER INTERFACE” filed on Apr. 22, 2014, which claims priority to Chinese Patent Application No. 201310593980.6, entitled “DATA OBJECT SELECTION METHOD, APPARATUS AND ELECTRONIC DEVICE,” filed on Nov. 21, 2013, both of which are incorporated by reference in their entirety.

### TECHNICAL FIELD

The present application relates generally to user interfaces that employ touch-sensitive displays, and more particularly, to operating (e.g., selecting and deselecting) on data items displayed on user interfaces of computing devices.

### BACKGROUND

Data items having an identical or similar shape are normally displayed on graphical user interfaces of portable electronic devices (e.g., smart phones, tablets, eBook readers and laptops) to represent data objects including applications, images, data files, file folders and the like. A user of a portable electronic device enables operations on the represented data objects by operating on the displayed data items.

A user normally clicks on each individual data item to select a corresponding data object on a touch-sensitive display of a portable electronic device. For example, data items displayed on a smart phone share a rectangular or square shape with rounded corners, and each represents a respective image file. When specific images need to be selected, the user clicks on each interested data item, and the smart phone receives a respective clicking signal on the touch-sensitive display. If the clicked data item was not selected originally before the click, it is selected thereafter, while if the clicked data item was already selected, the selection is disabled, and the clicked data item is not selected any more after the click.

The above selecting and deselecting operations on individual data items have their drawbacks when multiple data items need to be selected or deselected (e.g., when twenty images need to be selected for deletion). The user needs to successively click on each individual data item of the multiple data items. This manner of operation involves a large amount of individual click operations and takes a long operation time to complete, which may significantly reduce the battery life of the portable electronic device and may even reduce the device life in the long term. Accordingly, there is a need for using a more efficient and user-friendly method to operate on multiple data items that are displayed on the graphical user interface of the portable electronic devices.

### SUMMARY

The above deficiencies and other problems associated with the conventional approaches of operating on multiple data items displayed on a graphical user interface (GUI) are reduced or eliminated by the present application disclosed below. In some embodiments, the present application is implemented in a computing device (e.g., a portable electronic device) that has one or more processors, memory and one or more modules, programs or sets of instructions stored in the memory for performing multiple functions. Instructions for performing these functions may be included in a computer program product configured for execution by one or more processors.

One aspect of the present application is a method for controlling data items displayed on a touch-sensitive display of a computing device. The method includes, at the computing device, displaying a plurality of data items on a graphical user interface of the touch display, and detecting a sequence of finger gestures on the touch display, wherein the sequence of finger gestures further includes a finger down gesture immediately followed by a finger moving gesture immediately followed by a finger up gesture. The method further includes in accordance with a determination that the sequence of finger gestures satisfy predefined conditions, identifying a set of the plurality of data items as being associated with the sequence of finger gestures and displaying a plurality of operations on the touch display, wherein the plurality of operations are determined at least in part based on an attribute of the identified set of data items.

Another aspect of the present application is a computing device that includes a touch display, one or more processors, and memory having instructions stored thereon, which when executed by the one or more processors cause the processors to perform operations to display a plurality of data items on a graphical user interface of the touch display, and detect a sequence of finger gestures on the touch display, wherein the sequence of finger gestures further includes a finger down gesture immediately followed by a finger moving gesture immediately followed by a finger up gesture. The processors in the computing device further perform operations to, in accordance with a determination that the sequence of finger gestures satisfy predefined conditions, identify a set of the plurality of data items as being associated with the sequence of finger gestures and display a plurality of operations on the touch display, wherein the plurality of operations are determined at least in part based on an attribute of the identified set of data items.

Another aspect of the present application is a non-transitory computer readable storage medium that stores at least one program configured for execution by at least one processor of a computing device having a touch display. The at least one program includes instructions to display a plurality of data items on a graphical user interface of the touch display and detect a sequence of finger gestures on the touch display, the sequence of finger gestures further including a finger down gesture immediately followed by a finger moving gesture immediately followed by a finger up gesture. The at least one program further includes instructions to, in accordance with a determination that the sequence of finger gestures satisfy predefined conditions, identify a set of the plurality of data items as being associated with the sequence of finger gestures, and display a plurality of operations on the touch display, wherein the plurality of operations are determined at least in part based on an attribute of the identified set of data items.

Other embodiments and advantages may be apparent to those skilled in the art in light of the descriptions and drawings in this specification.

### BRIEF DESCRIPTION OF THE DRAWINGS

The above features and advantages of the present application as well as additional features and advantages thereof will be more clearly understood hereinafter as a result of a detailed description of preferred embodiments when taken in conjunction with the drawings.

FIG. 1 is an exemplary flow diagram illustrating a process for controlling a plurality of data items displayed on a GUI of a computing device according to some embodiments in the present application.

FIG. 2A is another exemplary flow diagram illustrating a process for controlling a plurality of data items on two successive pages displayed on a GUI of a computing device according to some embodiments in the present application.

FIGS. 2B-2M illustrate exemplary user interfaces displayed on a computing device that operates on a plurality of data items based on a sequence of finger gestures on a touch-sensitive display according to some embodiments in the present application.

FIG. 3 is an exemplary block diagram illustrating a system for controlling a plurality of data items displayed on a GUI display of a computing device according to some embodiments in the present application.

FIG. 4 is another exemplary block diagram illustrating a system for controlling a plurality of data items displayed on more than one page of a GUI display of a computing device according to some embodiments in the present application.

FIG. 5 is an exemplary block diagram illustrating a computing device according to some embodiments in the present application.

FIG. 6 is another exemplary block diagram illustrating a computing device according to some embodiments in the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be obvious to one skilled in the art that the subject matter may be practiced without these specific details. In other instances, well-known methods, procedures, components, modules, and circuits have not been described in detail so as not to unnecessarily obscure aspects of the embodiments.

In order to make a clear understanding of purposes, technical schemes and advantages of the present application, the present application is described in detail below with reference to the attached drawings. The described embodiments are merely examples of the present application, not the whole invention. In addition to the embodiments of the present application, all the other embodiments obtained by those skilled in the art without any creative labor belong to the protective scope of the present application.

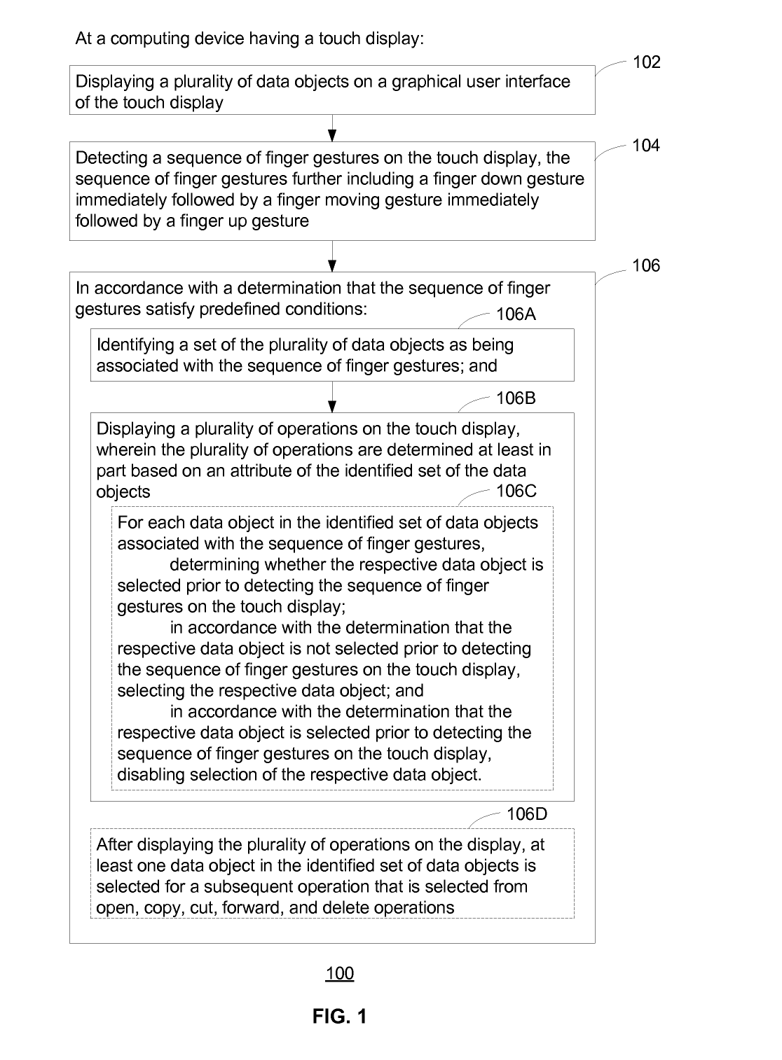

FIG. 1 is an exemplary flow diagram illustrating a process 100 for controlling a plurality of data items displayed on a GUI of a computing device according to some embodiments in the present application. In particular, process 100 for controlling the plurality of data items is performed on the computing device that displays the GUI. This computing device is optionally a portable electronic device that includes a touch-sensitive display (also called as a touch display) or a personal computer that includes input/output peripherals (e.g., a touch pad, a mouse or a display). In one specific example, the GUI is displayed on the touch-sensitive display in the portable electronic device.

Process 100 is, optionally, governed by instructions that are stored in a non-transitory computer readable storage medium and that are executed by one or more processors of the computing device. Each of the operations shown in FIG. 1 may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in process 100 may be combined and/or the order of some operations may be changed.

A plurality of data items are displayed (102) on the GUI displayed on the touch display of the computing device. In some embodiments, the plurality of data items have an identical or similar shape, and arranged as a list or an array. Each data item represents a data object, such as a software application, an email message, a music clip, a video clip, an image, a certain data file, a file folder and the like. In one specific example, each data item in a two-dimensional array of data items adopts a rectangular or square shape with rounded corners and represents an image.

In some implementations, the plurality of data items displayed simultaneously on the GUI represent a plurality of data objects that have the same data type. In various embodiments of the present application, a user of the computing device enables operations on the represented data objects by operating on the displayed data items. Strictly speaking, “data item” and “data object” refer to an icon displayed on a GUI and an object represented by the icon, respectively. However, in some places of the present application, “data item” is used in an indistinguishable and exchangeable manner with “data object.”

The computing device then detects (104) a sequence of finger gestures on the touch display. The sequence of finger gestures includes a finger down gesture immediately followed by a finger moving gesture immediately followed by a finger up gesture.

In some embodiments, the finger moving gesture includes a sliding action on the GUI and results in a finger sliding signal. Optionally, if the computing device is a portable electronic device that includes a touch display, this sliding action is generated when a finger of the user slides on the touch display and maintains a continuous finger contact with the touch display. Optionally, if the computing device is a personal computer that includes input/output peripherals (e.g., a touch pad, a mouse or a display), this sliding action is generated when a finger of the user slides on the touch pad, or when the mouse is dragged with its left mouse button being pressed down.

Further, the computing device determines whether the sequence of finger gestures satisfy predefined conditions. In accordance with a determination that the sequence of finger gestures satisfy predefined conditions, the computing device identifies (106A) a set of the plurality of data items as being associated with the sequence of finger gestures, and displays (106B) a plurality of operations on the touch display. The plurality of operations are determined at least in part based on an attribute of the identified set of data items.

In some implementations, the attribute of the identified set of the data items includes whether each data item in the identified set of data items is selected prior to detecting the sequence of finger gestures on the touch display. For each data item in the identified set of data items associated with the sequence of finger gestures, the computing device displays the plurality of operations on the touch display by determining (106C) whether the respective data item is selected prior to detecting the sequence of finger gestures on the touch display. In accordance with the determination that the respective data item is not selected prior to detecting the sequence of finger gestures on the touch display, the respective data item is selected (106C) as displayed on the GUI. On the other hand, in accordance with the determination that the respective data item is selected prior to detecting the sequence of finger gestures on the touch display, selection of the respective data item is disabled (106C) as displayed on the GUI.

As explained here with reference to the above implementations, process 100 for controlling the plurality of data items displayed on a GUI is applied for selecting or deselecting more than one data item using the sequence of finger gestures, and sometimes, primarily using the finger moving gesture. Under some circumstances, the finger moving gesture may be as simple as a sliding action on the touch display. Thus, process 100 for controlling the plurality of data items solves many problems that exist in some data item selection methods, and particularly, may reduce the number of user operations (e.g., clicks) on the touch display and the overall operation time.

In some implementations, after displaying the plurality of operations on the touch display, at least one data item in the identified set of data items is selected (106D) for a subsequent operation that is optionally an open, copy, cut, forward, or delete operation. In one example, the identified set of data items includes a set of email messages that are selected together for a subsequent deletion. In another example, the identified set of data items includes multiple images that are selected together for being uploaded to a website.

In some implementations, in accordance with the predefined conditions, when a path where the finger moving gesture contacts the touch display includes a closed loop, the identified set of data items include data items that are enclosed in the closed loop, and the enclosed data items are further processed by the plurality of displayed operations on the touch display. In some implementations, the identified set of data items also include data items that are located on the path in addition to those data items enclosed in the closed loop. After displaying the plurality of operations on the touch display, at least one data item in the identified set of data items is processed by a subsequent operation, such as an open, copy, cut, forward, or delete operation. In one specific example, the closed loop includes a set of data items associated with images, and more than one data item in the data item set is selected in accordance with the plurality of operations and may be deleted, copied, or uploaded together in subsequent operations.

In addition to the finger down gesture, the finger moving gesture and the finger up gesture, the sequence of finger gestures on the touch display optionally includes a click on a specific data item of the plurality of data items. The click on the specific object follows the finger up gesture. When it is determined that the specific data item was not previously selected prior to the click, the specific data item is selected upon displaying the plurality of operations on the touch display. Otherwise, when it is determined that the specific data item was previously selected prior to the click, the specific data item is deselected upon displaying the plurality of operations on the touch display. This specific data item is optionally included in the set of data objects identified as being associated with the sequence of finger gestures.

Under some circumstances, for the finger moving gesture, movement of the finger passes a specific data item of the identified set of data items twice, and two opposite operations are displayed for the specific data item, when the movement of the finger passes the specific data item for the first time and for the second time, respectively. For example, when the specific data item was not previously selected prior to detecting the sequence of finger gestures, the specific data item is first displayed as being selected and then as being unselected when the finger passes the specific data item on two instants when the finger moving gesture in the sequence of finger gestures passes the specific data item.

In some embodiments, the predefined conditions include that a respective finger contact on a corresponding data item, included in the sequence of finger gestures, has to last for a time duration that is longer than a predetermined threshold touch time. When this predefined condition is satisfied, the corresponding data item is identified as one data item in the set of the plurality of data items that are associated with the sequence of finger gestures. In some situations, the sequence of finger gestures may involve a large number of data items, and however, those data items that the finger merely passes without pausing thereon are not identified for subsequent displaying the plurality of operations.

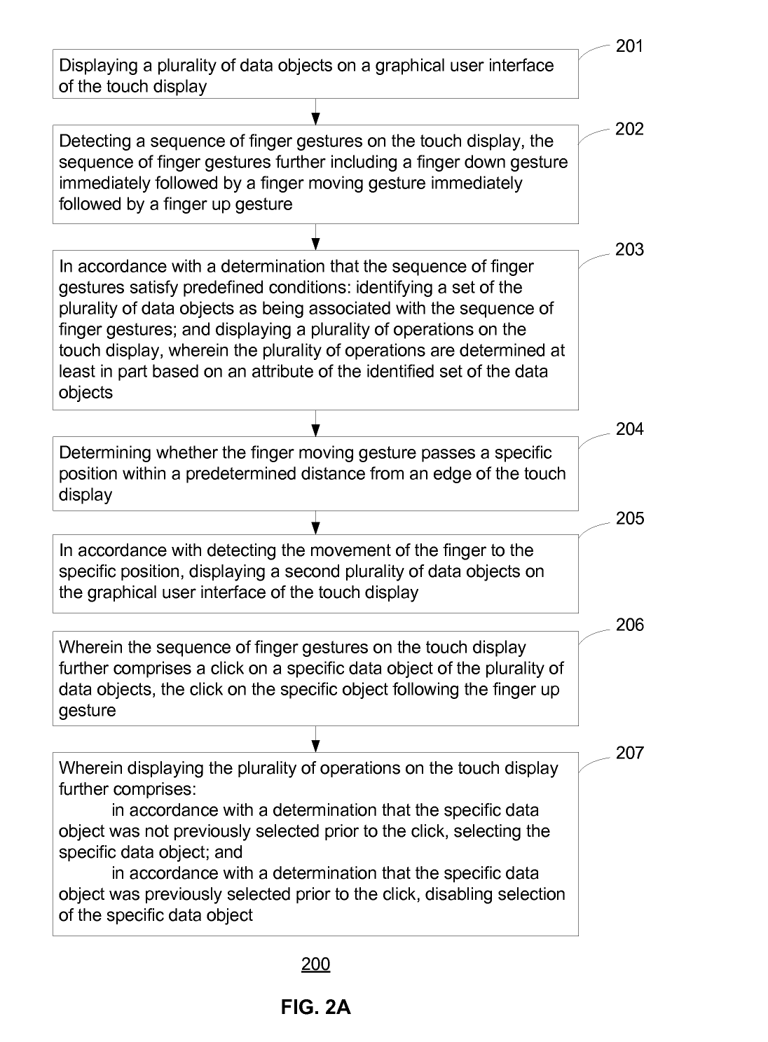

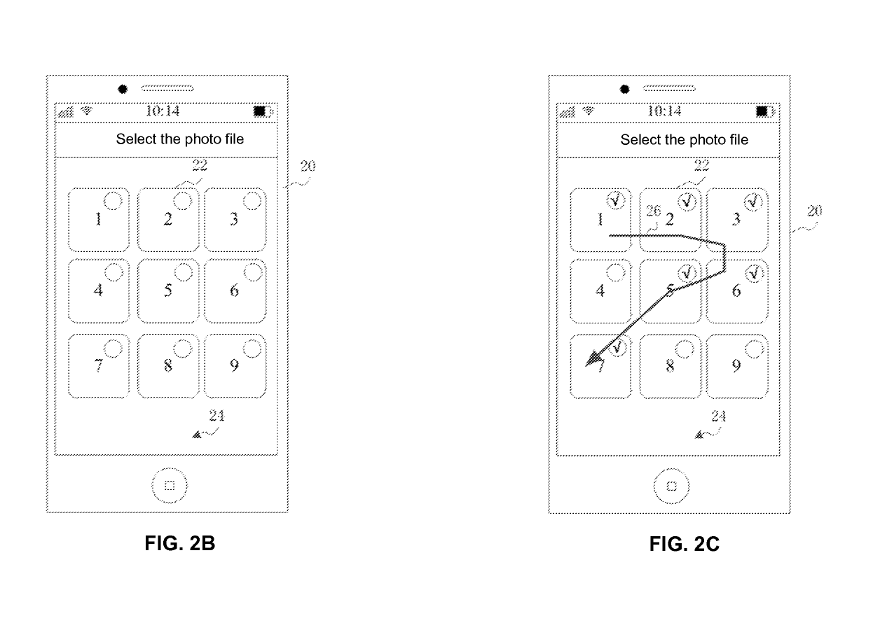

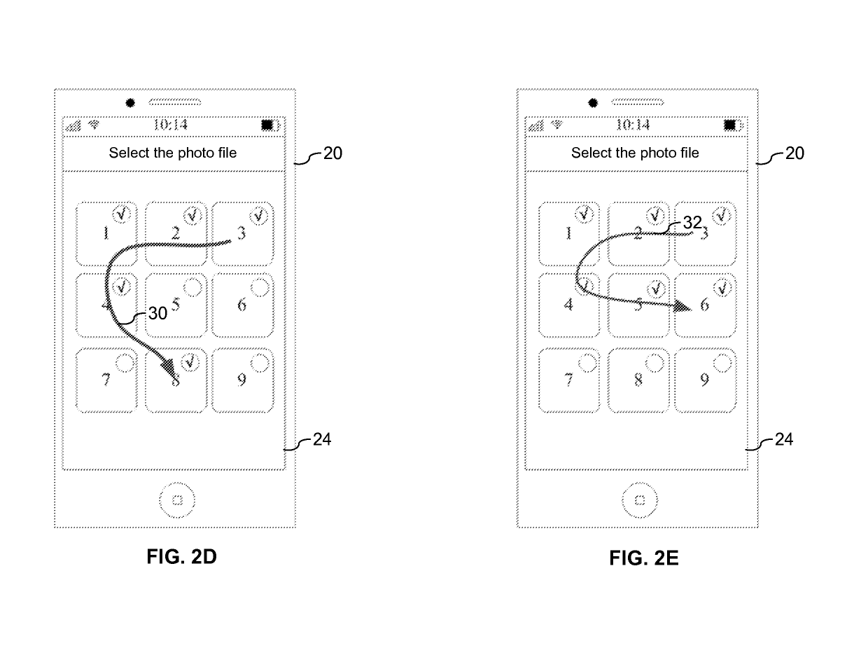

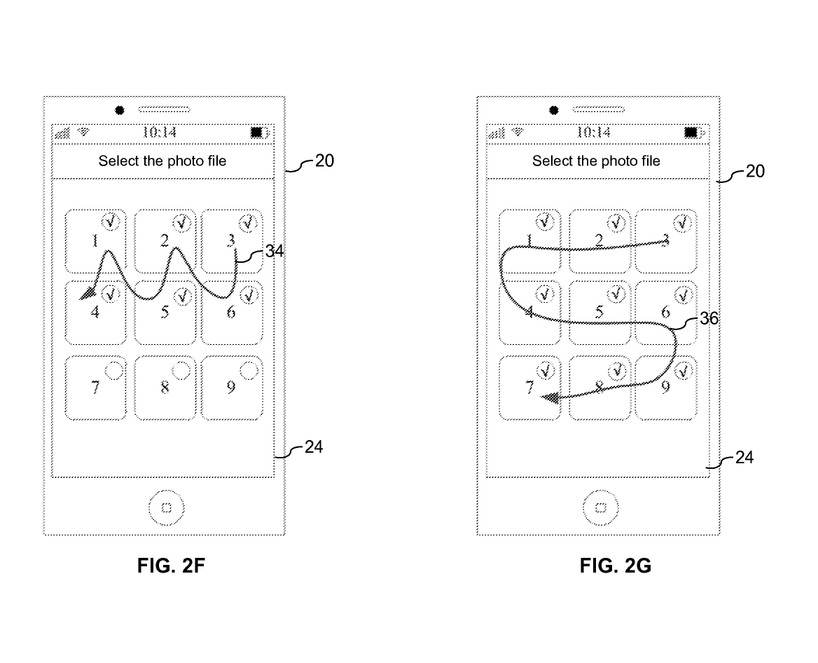

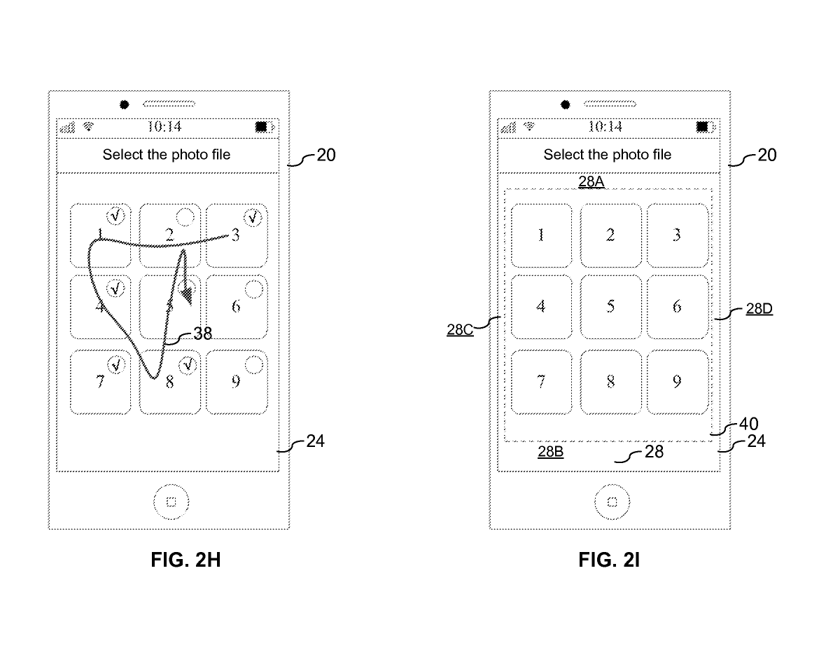

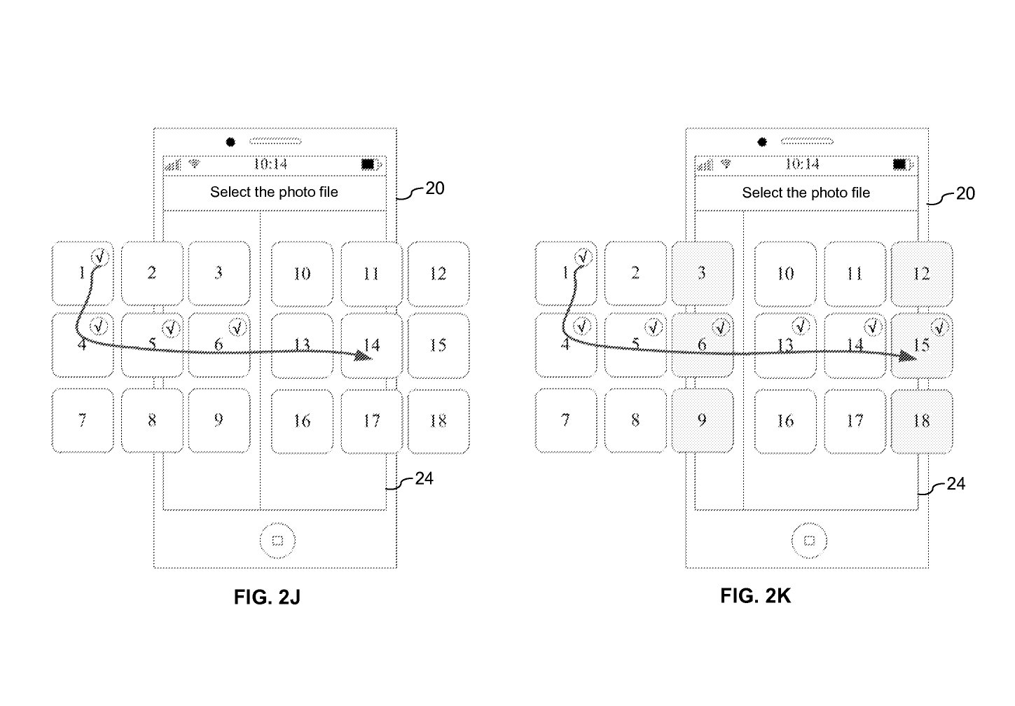

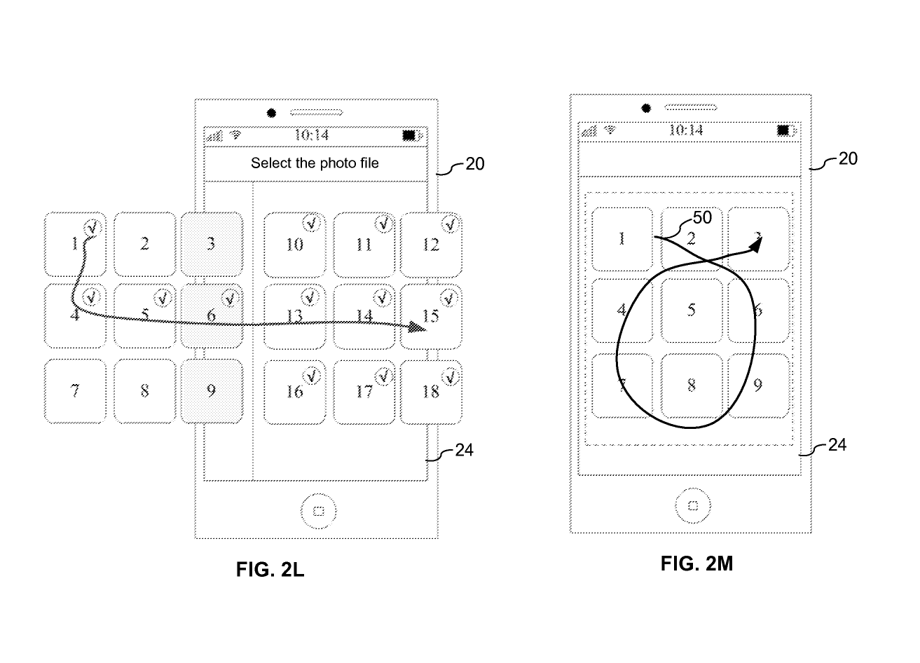

It should be understood that the particular order in which the operations in FIG. 1 have been described are merely exemplary and are not intended to indicate that the described order is the only order in which the operations could be performed. One of ordinary skill in the art would recognize various ways to control a plurality of data items on a GUI of a computing device as described herein. Additionally, it should be noted that details of other processes described with respect to process 200 (e.g., FIG. 2A) and user interfaces in FIGS. 2B-2M are also applicable in an analogous manner to process 100 described above with respect to FIG. 1. For brevity, these details are not repeated here.

FIG. 2A is another exemplary flow diagram illustrating a process 200 for controlling a plurality of data items on two successive pages displayed on a GUI of a computing device according to some embodiments in the present application. Like process 100, process 200 for controlling the plurality of data items on two successive pages is performed on the computing device that includes the GUI. This computing device is optionally a portable electronic device that includes a touch-sensitive display or a personal computer that includes input/output peripherals (e.g., a touch pad, a mouse or a display).

Process 200 is, optionally, governed by instructions that are stored in a non-transitory computer readable storage medium and that are executed by one or more processors of the computing device. Each of the operations shown in FIG. 2A may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in process 200 may be combined and/or the order of some operations may be changed.

A plurality of data items are displayed (201) on a GUI displayed on a touch display of a computing device. The computing device then detects (202) a sequence of finger gestures on the touch display, and determines whether the sequence of finger gestures satisfy predefined conditions. In accordance with a determination that the sequence of finger gestures satisfy predefined conditions, the computing device identifies (203) a set of the plurality of data items as being associated with the sequence of finger gestures, and displays (203) a plurality of operations on the touch display. The plurality of operations is determined at least in part based on an attribute of the identified set of data items. The plurality of data items are included in a first page of the two successive pages displayed on the GUI, and further includes a first plurality of data items. More details on operations 201-203 concerning the first plurality of data items displayed on the first page of the GUI are explained above with reference to FIG. 1. For brevity, these details are not repeated here.

It is then determined (204) whether the finger moving gesture passes a specific position located within a predetermined distance from an edge of the touch screen (i.e., within a determined boundary region). The determination triggers whether a page flipping action has to occur to replace the first page of data items with a new page of data items. In a specific example, the predetermined distance is 1 cm. In some embodiments, the specific position is within the predetermined distance from any one of the four edges of the touch display.

In accordance with detecting the movement of the finger to the specific position within the predetermined boundary region, a second plurality of data items are displayed (205) on the graphical user interface of the touch display. The second plurality of data items are included on the second page of the two successive pages displayed on the GUI. In some embodiments, the second plurality of data items enter the GUI along a page flipping direction, while the first plurality of data items exit the GUI along the same page flipping direction. More details concerning operations on the second plurality of data items are explained below with reference to FIGS. 2I-2L.

In some implementations, the sequence of finger gestures on the touch display includes (206) a click on a specific data item of the plurality of data items. The click on the specific object follows the finger up gesture. When it is determined that the specific data item was not previously selected prior to the click, the specific data item is selected (207). Otherwise, when it is determined that the specific data item was previously selected prior to the click, the specific data item is deselected (207).

Therefore, if the user intends to disable selection of a certain data item, the user may optionally extends the original finger moving gesture (e.g., a sliding action) on the touch display to the selected data item for a second time or clicks on the selected data item separately for the purposes of disabling the selection. For example, when the computing device receives a click on a selected photo file, the computing device displays that the status of the photo file changes from “selected” into “unselected.” In some embodiments, the data object representing a selected photo file is associated with a tick sign displayed in a circle superimposed on the displayed data item, while the data object representing an unselected photo file is associated with a blank circle without the tick sign.

It should be understood that the particular order in which the operations in FIG. 2A have been described are merely exemplary and are not intended to indicate that the described order is the only order in which the operations could be performed. One of ordinary skill in the art would recognize various ways to control a plurality of data items on a GUI of a computing device as described herein. Additionally, it should be noted that details of other processes described with respect to process 100 (e.g., FIG. 1) and user interfaces in FIGS. 2B-2M are also applicable in an analogous manner to process 200 described above with respect to FIG. 2A. For brevity, these details are not repeated here.

FIGS. 2B-2M illustrate exemplary user interfaces 20 of a computing device that operates on a plurality of data items based on a sequence of finger gestures on a touch-sensitive display according to some embodiments in the present application. More details concerning processes 100 and 200 are explained herein with reference to FIGS. 2B-2M.

As shown in FIG. 2B, mobile device 20 displays a GUI 24 for selecting data items on a touch-sensitive display (also called as a touch display). The GUI 24 includes nine data items 22 arranged in a 3×3 array, and each represents a photo image. The data items adopt the same square shape that has four rounded corners. Each data item also include a blank circle that is superimposed on the respective square. When the respective data item is selected, the circle is filled with a tick sign. However, when the respective data item is not selected, the circle is left blank as shown herein. In this embodiment, data items 1-9 are not selected on GUI 24 of computing device 20.

When a user places his finger(s) on or substantially close to the touch display, sensors integrated on the touch display detect the contact or proximity of the finger(s). In some situations, the user merely touches the touch display briefly (e.g., clicks on the touch display). When the finger touches or clicks on one data item 22, an operation is enabled on the corresponding data object represented by the touched data item. Under some circumstances, the data item is not selected prior to the touch or click, and subsequently selected upon the touch or click. Under some circumstances, the data item is already selected prior to the touch or click, and the selection is disabled upon the touch or click. In particular, when two successive clicks are applied on an unselected data item, the data item is selected upon the first click and deselected upon the second click.

In some situations, the user applies a sequence of finger gestures on the touch display, and the sequence of finger gestures includes a finger down gesture that is immediately followed by a finger moving gesture immediately followed by a finger up gesture. In the finger moving gesture, the user's finger slides through at least a part the touch display based on the GUI 24 displayed on the touch display. Stated another way, the user's finger moves a finger of the user on the touch display while maintaining a continuous finger contact with the touch display. As a result of the user's finger contact, the touch display senses a corresponding finger sliding action (or a finger sliding signal) along a specific path. FIG. 2C illustrates an exemplary GUI 24 of computing device 20 according to some embodiments of the present application. The corresponding finger sliding signal created by the user's finger contact is associated an irregular path 26. In some embodiments, path 26 adopts an irregular serpentine shape.

As shown in FIG. 2C, path 26 passes data items 1, 2, 3, 6, 5 and 7 as the user's finger slides over the touch display. If data items 22 (including items 1-9) that represent nine photos are not selected prior to the finger contact along path 26, data items 1, 2, 3, 6, 5 and 7 are successively selected due to the sequence of finger gestures on GUI 24 of the touch display.

FIGS. 2D-2G illustrate a plurality of paths 30-36 that are followed by a finger move gesture to successively select data items displayed thereon according to some embodiments of the present application. In FIG. 2D, the finger sliding signal received by mobile device 20 follows a path 30, when the user needs to select data items 1, 2, 3, 4 and 8. In FIG. 2E, the finger sliding signal received by the mobile device 20 follows a path 32, and data items 3, 2, 1, 4, 5 and 6 are successively selected when the user's finger moves over these data items. In FIG. 2F, the finger sliding signal received by mobile device 20 follows a zigzag path 34, and data items 3, 6, 2, 5, 1, and 4 are successively selected. In FIG. 2G, the finger sliding signal received by mobile device 20 follows a path 36 having a serpentine shape, such that data items 1-9 are all selected.

According to various embodiments shown in FIGS. 2D-2G, the displayed operations on the touch display are associated with selecting the identified data items that are included on the respective path. However, the displayed operations are not limited to selecting unselected data items. If the original state of a data item on the respective path is on a selected state before the finger movement reaches the data item, mobile device 20 displays a distinct operation of changing the selected state of the data item to an unselected state after the data item are passed through by the finger sliding signal.

In addition to selecting or deselecting data items, a finger sliding signal is also applicable for selecting a data item and deselecting the selected data item within one sequence of finger gestures. As shown in FIG. 2H, in some embodiments, data items 2 and 5 are in the unselected state prior to the sequence of finger gestures. Path 38 of the finger sliding signal received by mobile device 20 passes data items 2 and 5 twice, when the user needs to select data items 1, 3, 4 and 8 in one continuous finger moving gesture. During the course of selection, the finger moving gesture first passes data items 3, 2, 1, 4 and 8 successively, and these data items are selected. However, when the user finds data item is not the one he wants, he may optionally slide up from data item 8 to data item 2, passing through data item 5, and further slide down to terminate at data item 5. Therefore, data item 2 is passed through by the finger sliding signal for the second time, and returns to the unselected state from the selected state. On the other hand, data item 5 is also passed through for twice, and thereby maintains an unselected state after the sequence of finger gestures. As a result of the finger gesture along the path 38, data items 1, 3, 4 and 8 are conveniently selected in one continuous finger moving gesture, although these data items are substantially isolated from each other.

In some implementations, when data items 1, 3, 4 and 8 need to be selected, a sequence of finger gestures that includes a continuous finger moving gesture are used to select 3, 2, 1, 4 and 8. After the finger up gesture in the sequence of finger gestures is completed, the user may click on data item 2 separately to disable the unneeded selection of data item 2 due to the continuous finger moving gesture.

In some implementations, for each data item in the identified set of data items that are located on the path of the finger moving gesture, it is required that the corresponding finger contact on the respective data item must last for a time longer than a predetermined threshold touch time in order to identify the respective data item. For example, in some embodiments, data items included on the paths on FIGS. 2C-2H are identified and operated on (e.g., selected or deselected), only when the requirement for the finger contact time is satisfied. In a specific example, the finger contact time must last for more than 0.5 second.

The number of data items that can be accommodated in GUI 24 for simultaneous display is limited, and for example, as shown in FIGS. 2B-2H, the number is 9 for this set of embodiments. Thus, data items need to be displayed on successive pages on GUI 24 of the computing device. Process 200 for controlling a plurality of data items is applicable to identify and operate (e.g., select and deselect) on data items displayed on GUI 24 via a sequence of finger gestures.

FIG. 2I illustrates an exemplary GUI 24 that includes a predetermined boundary region 28 according to some embodiments of the present application. Boundary region 28 extends from the edges of GUI 24 to a respective predetermined distance from a corresponding edge of GUI 24. Here, boundary region 28 is located between a virtual margin line 40 and a frame of GUI 24. In some implementations, boundary region 28 is set forth on four sides of GUI 24, and thus includes an upper preset boundary region 28A, a lower preset boundary region 28B, a left preset boundary region 28C and a right preset boundary region 28D. In a specific example, the predetermined distance is 1 cm. In another specific example, the predetermined distance is not identical to boundary regions 28A-28D.

In some implementations, mobile device 20 detects whether the finger moving gesture (or the finger sliding signal) passes a specific position that is located within boundary region 28 (i.e., within the predetermined distance from an edge of GUI 24). In accordance with detecting the movement of the figure to the specific position located within boundary region 28, GUI 24 flips over to display a different page that contains another set of data items. In some implementations, data items on the original page (the first plurality of data items including items 1-9) exits the GUI 24 along a page flipping direction, and the set of data items (the second plurality of data items including items 10-18) enters GUI 24 along the same page flipping direction.

In some embodiments, the specific position reached by the movement of the finger is located within the upper preset boundary region, the page flipping direction is downward towards the lower preset boundary region. The first plurality of data items exits the GUI 24 from the lower preset boundary region, and the second plurality of data items enters GUI 24 from the upper preset boundary region. In some embodiments, the specific position reached by the movement of the finger is located within the lower preset boundary region, the page flipping direction is upward towards the upper preset boundary region. The first plurality of data items exits the GUI 24 from the upper preset boundary region, and the second plurality of data items enters GUI 24 from the lower preset boundary region. In some embodiments, the specific position reached by the movement of the finger is located within the left preset boundary region, the page flipping direction is to the right. The first plurality of data items exits the GUI 24 from the right preset boundary region, and the second plurality of data items enters GUI 24 from the left preset boundary region. In some embodiments, the specific position reached by the movement of the finger is located within the right preset boundary region, the page flipping direction is to the left. The first plurality of data items exits the GUI 24 from the left preset boundary region, and the second plurality of data items enters GUI 24 from the right preset boundary region.

In some embodiments, a part of the first plurality of data items and another part of the second plurality of data items are simultaneously displayed on GUI 24 during the course of flipping pages thereon.

In some implementations, the movement of the finger reaches the specific position located on the right preset boundary region, and the second plurality of data items enters into GUI 24 from the right as shown in FIGS. 2J-2L. According to FIG. 2J, during the course of flipping to the second page, mobile device 20 does not operate (e.g., select or deselect) on any data item of the second plurality of data items, and maintains their original state. The user may then continue the sequence of finger gestures or apply another sequence of finger gestures to operate on the second plurality of data items (items 10-18). However, in some embodiments, after flipping over to the next page on GUI 24, the process of operating on the second plurality of data items may be different from process 100 that is applied to control the first plurality of data items.

In some implementations, according to FIG. 2K, during the course of flipping to the second page, mobile device 20 identifies and operates on (e.g., selects or deselects) a set of data items included in the second plurality of data items on the second page. The set of data items passes the specific position where the movement of the finger is located (i.e., the specific position located in boundary region 28) and are therefore identified as being associated with the sequence of finger gestures, when the second plurality of data items enters GUI 24 along the page flipping direction. Then, displaying the plurality of operations on the touch display also includes a respective operation on each data item in the passing set of data items of the second plurality of data items. In particular, in some implementations, in accordance with a determination that the respective data item (e.g., item 13-15) is not selected prior to entering GUI 24, the respective data item is selected, and in accordance with a determination that the respective data item is selected prior to entering GUI 24, the selection of the respective data item is disabled.

In some implementations, according to FIG. 2L, during the course of flipping to the second page, mobile device 20 identifies all data items on the second page as being associated with the sequence of finger gestures, and operates on (e.g., selects or deselects) all the data items in the second plurality of data items on the second page, independently of the specific position of the finger. Thus, displaying the plurality of operations on the touch display also includes a respective operation on each data item of the second plurality of data items. In particular, in some implementations, in accordance with a determination that the respective data item (e.g., item 10-18) is not selected prior to entering GUI 24, the respective data item is selected, and in accordance with a determination that the respective data item is selected prior to entering GUI 24, the selection of the respective data item is disabled.

Further, in some implementations, the movement of the finger continues to stay on the specific position located in the preset boundary region 28, and mobile phone 20 continues to flip over to new few pages according to a predetermined rate. Mobile device 20 continues to operate on the second plurality of data items according to various processes, such as those explained above with reference to FIGS. 2J-2L.

Further, according to some embodiments as shown in FIG. 2M, path 50 of the finger moving gestures includes a closed loop, a set of data items (e.g., items 5 and 8) are enclosed in the closed loop, and the enclosed data items are further operated on the touch display. In some embodiments, the data items (e.g., items 2, 4, 6, 7 and 9) that are located on the closed loop are also operated on. In some embodiments, mobile device 20 identified and operates on all data items (items 1-9) including those located on the closed loop (e.g., items 2, 4, 6, 7 and 9), those located on path 50 but not on the closed loop (e.g., item 3), and those enclosed in the closed loop but not on path 50 (e.g., items 5 and 8).

In many of the aforementioned embodiments, processes 100 and 200 for controlling data items are used for selecting and unselecting multiple data items through a sequence of finger gestures that may just be a sliding action on the touch display. Such processes solve the existing problems in some data item selection methods that require many operations and time, and achieve the effect that only a simple finger moving gesture (or a finger sliding signal) is needed to select multiple data items.

It should be noted that the embodiments in FIGS. 2B-2M are merely examples involving an array of data items, each having a rounded rectangle shape. One of those skilled in the art knows that processes 100 and 200 for controlling data items may be used for the data item in the other forms (e.g., a list of contact information in an address book).

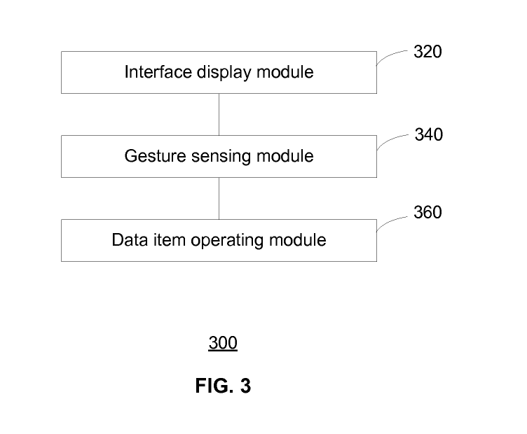

FIG. 3 is an exemplary block diagram illustrating a system 300 for controlling a plurality of data items displayed on a GUI display of a computing device according to some embodiments in the present application. Data item controlling system 300 is included in the computing device, and all or part of system 300 is optionally implemented by software, hardware or the combination of software and hardware. Data item controlling system 300 includes Interface display module 320, gesture sensing module 340 and data item operating module 360.

Interface display module 320 is configured to display GUI 240 that displays a plurality of data items. Gesture sensing module 340 is configured to sense a sequence of finger gestures (including the finger up gesture, the finger down gesture and the finger moving/sliding gesture), and identifies a set of the plurality of data items on GUI 240 of the computing device according to the sequence of finger gestures. Data item operating module 360 is configured to operate on (e.g., select or deselect) the identified set of data items and display these operations on the touch display of the computing device.

Optionally, data item operating module 360 further includes a data item selecting unit and a data item deselecting unit. In some embodiments, the data item selection unit is configured to select a corresponding data item in accordance with a determination that the data item is not selected before a finger moving gesture sensed by gesture sensing module 340 passes the data item. On the opposite, the data item deselecting unit is configured to disable selection of a corresponding data item in accordance with a determination that the data item is selected before a finger moving gesture sensed by gesture sensing module 340 passes the data item.

More details on functions of modules 320, 340 and 360 are explained above with reference to FIGS. 1 and 2A-2M.

FIG. 4 is another exemplary block diagram illustrating a system 400 for controlling a plurality of data items displayed on more than one page of a GUI display of a computing device according to some embodiments in the present application. Data item controlling system 400 is included in the computing device, and all or part of system 400 is optionally implemented by software, hardware or the combination of the two. In addition to modules 320, 340 and 360, data item controlling system 300 further includes click sensing module 350, a region detection module 370 and a page flipping module 380. More details on functions of modules 320, 340 and 360 are explained above with reference to FIG. 3.

In some implementations, click sensing module 350 is configured to sense a click on a data item, independently of whether the data item is selected or not. In some embodiments, click sensing module 350 is a part of gesture sensing module 340.

In some implementations, region detection module 370 is configured to detect whether the sequence of finger gestures sensed by gesture sensing module 340 includes a finger contact on a specific position in a predetermined boundary region, and particularly, the specific position is located within a predetermined distance from an edge of GUI 240 on the touch display of the computing device.

In some implementations, page flipping module 380, coupled to region detection module 370, is configured to flip to a different page that contains a second plurality of data items for display on GUI 240, when the finger moving gesture reaches the predetermined boundary region. When the detection result of region detection module 370 indicates that the sequence of finger gestures includes a finger contact on a specific position in the preset boundary region on GUI 240, page flipping module 380 moves the first plurality of data items out of display on GUI 240, and moves the second plurality of data items in for display on GUI 240. Specifically, page flipping module 380 is configured to move the first and second plurality of data items along the same page flipping direction. In particular, page flipping module 380 is configured to collaborate with data item operating module 360 to operate on the second plurality of data items. More details concerning operations on the first and second plurality of data items are explained above with reference to FIG. 2A and FIGS. 2I-2K. For brevity, these details are not repeated here.

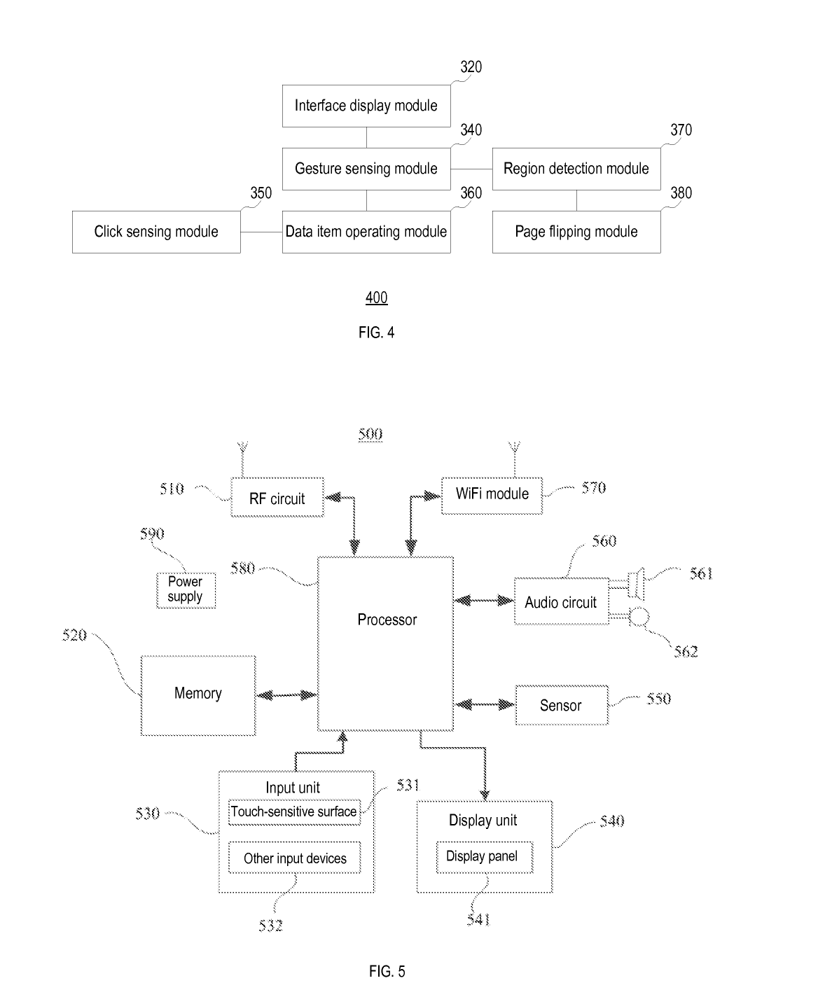

FIG. 5 is an exemplary block diagram illustrating a computing device 500 according to some embodiments in the present application. Computing device 100 is used for implementing data item controlling processes 100 and 200. Computing device 500 may include RF (Radio Frequency) circuit 510, memory 520 further including one or more computer-readable storage media, input unit 530, display unit 540, sensor 550, audio circuit 560, Wi-Fi (Wireless Fidelity) module 570, processor 580 including one or more than one processing cores, power supply 590 and other parts. One of those skilled in the art understands that the specific embodiment of computing device shown in FIG. 5 does not constitute a limitation to computing device 500, and computing device 500 may optionally include more or less parts than the illustrated parts, a combination of some illustrated parts with other parts that are not illustrated herein, or different arrangements of the illustrated parts.

RF circuit 510 is configured to send and receive information or signals. In some implementations, RF circuit 510 in a mobile device is configured to receive downlink information of a base station and hand the received downlink information over to one or more processors 580 for further processing. Further, RF circuit 510 is also configured to send the involved uplink data to the base station. Generally, RF circuit 510 includes, but is not limited to, antenna, at least one amplifier, tuner, one or more oscillators, subscriber identity module (SIM) card, transceiver, coupler, LNA (Low Noise Amplifier), and duplexer. In addition, RF circuit 510 can communicate through wireless communication network and other devices. The wireless communication network may use any communication standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), E-mail, and SMS (Short Messaging Service).

Memory 520 is also configured to store software program and module, and processor 580 then executes the stored software program and module to enable various functions and data processing. In some embodiments, memory 520 includes a program area that stores an operation system, one or more application program required for at least one function (such as sound play function, image play function). Memory 520 further includes a data area that stores the data created according to use of computing device 500 (such as audio data, phone book, etc.) and so on. In addition, memory 520 may include high-speed random access memory, also include non-volatile memory, such as at least one disk storage device, flash memory devices, or other volatile solid state memory elements. Accordingly, memory 520 may also include memory controller, configured to provide processor 580 and input unit 530 with the access to memory 520.

Input unit 530, configured to receive the inputting of numeric or character information, and generate signal input of keyboard, mouse, joystick, optical or trackball related to user settings and function control. Specifically, input unit 530 includes touch-sensitive surface 535 and other input devices 532. Touch-sensitive surface 535, also known as touch screen or touchpad, configured to collect touch operation on or near it by user (such as operations of user using finger, stylus, and any other suitable object or attachment on touch-sensitive surface 535 or near touch-sensitive surface 535), and according to preset program to drive the corresponding connecting apparatus. Optionally, touch-sensitive surface 535 includes two parts of touch detection apparatus and touch controller. Among which, touch detection apparatus detects the touch direction of user and signal brought by touch operation, and transmits this signal to touch controller; touch controller receives touch information from touch detection apparatus, converts it into contact coordinate, then sends it to processor 580, and it can receive and execute the command sent by processor 580. In addition, touch-sensitive surface 535 can be made by various types including resistance type, capacitance type, infrared ray type and surface acoustic wave. Input unit 530 also includes other input devices 532 besides touch-sensitive surface 535. Specifically, other input devices 532 including but not limited to physical keyboard, function key (such as volume control key, switch key, etc.), trackball, mouse, joystick, etc.

Display unit 540 is configured to display the input information of user or the information provided for user and various graphical user interfaces of computing device 500, and these graphical user interface consisting of graph, text, icon, video and random combination of them. Display unit 540 may include display panel 545, optionally, such forms as LCD (Liquid Crystal Display), OLED (Organic Light-Emitting Diode) can be used to configure display panel 545. Furthermore, touch-sensitive surface 535 can cover display panel 545, when touch operation is detected on or near touch-sensitive surface 535, it transmits touch operation to processor 580 for determining the type of touch event, after which, processor 580, according to the type of touch event, provides corresponding visual output on the display panel 545. Although in FIG. 5, touch-sensitive surface 535 and display panel 545 are configured as two separate components to achieve input and output functions, however, in certain embodiments, touch-sensitive surface 535 can be integrated with display panel 545 for realization of input and output functions.

The computing device 500 also includes at least one sensor 550, such as light sensor, motion sensor and other sensors. Specifically, light sensor may include ambient light sensor and proximity sensor, herein, ambient light sensor is configured to adjust the brightness of the display panel 545 according to the light and shadow of ambient light, and proximity sensor is configured to turn off display panel 545 and/or backlight when computing device 500 moves to ear. As a motion sensor, gravity sensor can detect acceleration at each direction (generally triaxial), and magnitude and direction of gravity when it is stationary, and can be used for application of recognition of phone posture (such as horizontal and vertical screen switching, related games, magnetometer posture calibration), vibration recognition related functions (such as pedometer, percussion), etc.; redundant description for gyroscope, barometer, hygrometer, thermometer, infrared sensors and other sensors configured to computing device 500 will be avoided herein.

Audio circuit 560, speaker 565 and microphone 562 provide audio interface between user and computing device 500. Audio circuit 560 can transmit received electric signal from conversion of audio data to speaker 565, where electric signal is converted and output as acoustical signal by speaker 565; on the other hand, microphone 562 converts the collected acoustical signal into electric signal, which is received and converted as audio data by audio circuit 560, after which, audio data is output from processor 580 for processing, followed by being sent to another terminal through RF circuit 510, or audio data can be output to memory 520 for further processing. Audio circuit 560 may also include earplug jack to provide communication between peripheral headset and computing device 500.

Wi-Fi is short-range wireless transmission technology, and in some embodiments, allows a user of computing device 500 to send and receive email messages, browse the web page and access media streams. Stated another way, Wi-Fi module 570 provides users with a wireless access to broadband Internet. Although FIG. 5 shows Wi-Fi module 570, it can be understood that it is not a necessary component in computing device 500, and it may be neglected without changing nature of the present application.

As a control center of computing device 500, processor 580 uses various interfaces and circuits to couple components of the entire device, operates and executes software program and/or module stored in memory 520, and extracts the data stored in memory 520, implements various functions of computing device 500 and processes relevant data. Optionally, processor 580 can include one or more processing cores. Optionally, processor 580 integrates an application processor with a modem processor, wherein the application processor is configured to support an operating system, a user interface and other software applications and modem processor is configured to enable wireless communication. It is noted that in some embodiments the above modem processor is not integrated in processor 580.

Computing device 500 also includes power supply 590 used for the power supply of various parts (such as battery). In some embodiments, power supply can be connected logically with processor 580 by power supply management system, through which, charging, discharging, power management and other functions can be realized. In some embodiments, power supply 590 can also includes one or more DC or AC power supplies, recharging system, power failure detection circuit, power converter or inverter, power supply status indicators, and other components.

Although it is not shown herein, computing device 500 also can include camera, Bluetooth module and many other function units. In some implementations, display unit 540 is a touch-sensitive display. In some implementations, computing device 500 also includes memory and one or more programs, and the one or more programs are stored in memory. Through configuration, one or more processors is configured to perform data item controlling processes 10 and 200 provided by the embodiments as shown in the above FIG. 1 and FIG. 2A, respectively.

In some embodiments, data item controlling processes 100 and 200 may be realized in the hardware, software, firmware or other any combination thereof. If it is realized in the software, instructions and programs are stored in the computer readable medium to control data item controlling processes 100 and 200. The computer readable medium includes computer storage medium and communication medium, this communication medium includes any medium able to help send the computer programs from one specific position to another specific position. The storage medium may be any available medium generally or specially used for computer access.

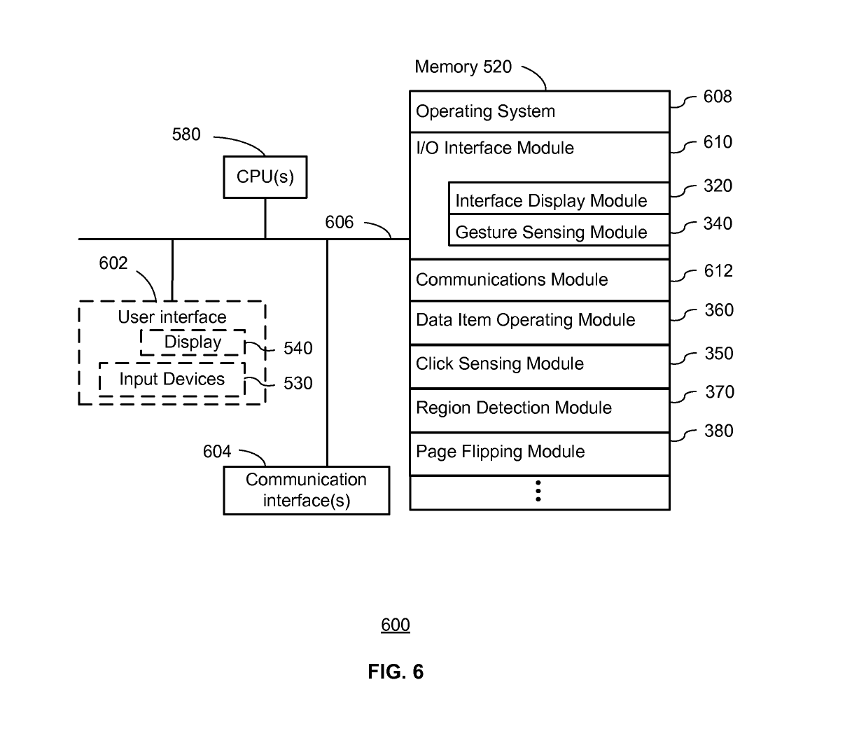

FIG. 6 is another exemplary block diagram illustrating a computing device 600 (such as a mobile device 20) according to some embodiments in the present application. In accordance with various embodiments of the application, computing device 600 is applied to control operations on a plurality of data items displayed on a graphical user interface (GUI) of computing device 600 as shown in FIGS. 1-5. In some implementations, computing device 600 at least includes one or more processors 580 (e.g., central processing units) and a memory 520 for storing data, programs and instructions for execution by one or more processors 580. In some implementations, computing device 600 further includes one or more communication interfaces 604, a user interface 602, and one or more communication buses 606 that interconnect these components.

In some embodiments, input/output (I/O) interface 602 includes an input unit 530 and a display unit 540. Examples of input unit 530 include a keyboard, a mouse, a touch pad, a game controller, a function key, a trackball, a joystick, a microphone, a camera and the like. Additionally, display unit 540 displays information that is inputted by the user or provided to the user for review. Examples of display unit 540 include, but are not limited to, a liquid crystal display (LCD) and an organic light-emitting diode (OLED) display. In some implementations, input unit 530 and display unit 540 are integrated on a touch-sensitive display that displays a graphical user interface (GUI).

In some embodiments, communication buses 606 include circuitry (sometimes called a chipset) that interconnects and controls communications between system components. In some embodiments, memory 520 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. In some embodiments, memory 520 includes one or more storage devices remotely located from the one or more processors 580. In some embodiments, memory 520, or alternatively the non-volatile memory device(s) within memory 520, includes a non-transitory computer readable storage medium.

In some embodiments, memory 520 or alternatively the non-transitory computer readable storage medium of memory 520 stores the following programs, modules and data structures, instructions, or a subset thereof:
Operating System 608 that includes procedures for handling various basic system services and for performing hardware dependent tasks;
I/O interface module 610 that includes procedures for handling various basic input and output functions through one or more input and output devices, wherein I/O interface module 610 further includes an interface display module 320 that controls displaying of a graphical user interface and a gesture sending module 340 that senses a sequence of finger gestures;
Communication module 612 that is used for connecting computing device 600 to other computing device 600, via one or more network communication interfaces 604 (wired or wireless) and one or more communication networks, such as the Internet, other wide area networks, local area networks, metropolitan area networks, and so on;
Data item operating module 360;
Click sensing module 350
Region detection module 370; and
Page flipping module 380.

More details on functions of modules 320-380 are explained above with reference to FIGS. 1-5. For brevity, they are repeated here.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. It shall also be noted that unless otherwise specified, each element or component in the figures of the present application may include one or more sub-elements or sub-components, and be grouped with other element(s) or component(s). While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method, comprising:
at a computing device having a touch display:
displaying a plurality of data items on a graphical user interface of the touch display;
detecting a sequence of finger gestures on the touch display, the sequence of finger gestures further including a finger down gesture immediately followed by a finger moving gesture immediately followed by a finger up gesture;
in accordance with a determination that the sequence of finger gestures satisfy predefined conditions:
identifying a set of the plurality of data items as being associated with the sequence of finger gestures; and
displaying a plurality of operations on the touch display, wherein the plurality of operations are determined at least in part based on an attribute of the identified set of data items.

2. The method in claim 1, wherein the attribute of the identified set of the data items comprises whether each data item in the identified set of data items is selected prior to detecting the sequence of finger gestures on the touch display, and displaying the plurality of operations on the touch display further comprises:
for each data item in the identified set of data items associated with the sequence of finger gestures,
determining whether the respective data item is selected prior to detecting the sequence of finger gestures on the touch display;
in accordance with the determination that the respective data item is not selected prior to detecting the sequence of finger gestures on the touch display, selecting the respective data item; and
in accordance with the determination that the respective data item is selected prior to detecting the sequence of finger gestures on the touch display, disabling selection of the respective data item.

3. The method in claim 1, wherein after displaying the plurality of operations on the display, at least one data item in the identified set of data items is selected for a subsequent operation that is selected from open, copy, cut, forward, and delete operations.

4. The method in claim 1, wherein in accordance with the predefined conditions, when a path where the finger moving gesture contacts the touch display includes a closed loop, the identified set of data items include data items that are enclosed in the closed loop, and the enclosed data items are further processed by the plurality of displayed operations on the touch display.

5. The method of claim 1, wherein the sequence of finger gestures on the touch display further comprises a click on a specific data item of the plurality of data items, the click on the specific object following the finger up gesture, and wherein displaying the plurality of operations on the touch display further comprises:
in accordance with a determination that the specific data item was not previously selected prior to the click, selecting the specific data item; and
in accordance with a determination that the specific data item was previously selected prior to the click, disabling selection of the specific data item.

6. The method of claim 1, further comprising:
determining whether the finger moving gesture passes a specific position within a predetermined distance from an edge of the touch display; and
in accordance with detecting the movement of the finger to the specific position, displaying a second plurality of data items on the graphical user interface of the touch display.

7. The method of claim 6, wherein the predetermined distance is 1 cm.

8. The method of claim 6, wherein the specific position is within the predetermined distance from any one of the four edges of the touch display.

9. The method of claim 6, wherein the second plurality of data items enter the graphical user interface of the touch display along a page flipping direction, while the first plurality of data items that are displayed on the graphical user interface of the touch display exits the user interface of the touch display along the same page flipping direction.

10. The method of claim 6, wherein when the second plurality of data items enter the graphical user interface of the touch display along a page flipping direction, a set of the second plurality of data items passes the specific position where the movement of the finger is located; and
wherein displaying the plurality of operations on the touch display comprises a respective operation on each data item in the passing set of data items of the second plurality of data items.

11. The method of claim 10, wherein the respective operation on each data item in the passing set of data items comprises:
in accordance with a determination that the respective data item is not selected prior to entering the graphical user interface, selecting the respective data item; and
in accordance with a determination that the respective data item is selected prior to entering the graphical user interface, disabling selection of the respective data item.

12. The method of claim 6, wherein for each data item in the second plurality of data items, and displaying the plurality of operations on the touch display further comprises:
in accordance with a determination that the respective data item is not selected prior to entering the graphical user interface, selecting the respective data item; and
in accordance with a determination that the respective data item is selected prior to entering the graphical user interface, disabling selection of the respective data item.

13. The method of claim 1, wherein the plurality of data items on the graphical user interface of the touch display comprises a list or an array of data items, and each data item is selected from an image, an email message, a software application, a music clip, a video clip and a file folder.

14. The method of claim 1, wherein the movement of the finger passes a specific data item of the identified set of data items twice, and two opposite operations are displayed for the specific data item, when the movement of the finger passes the specific data item for the first time and for the second time, respectively.

15. The method of claim 1, wherein for each data item in identified set of data items, the predefined conditions includes that the respective finger contact on a corresponding representation of the respective data item, included in the sequence of finger gestures, lasts for a time duration that is longer than a predetermined threshold touch time.

16. A computing device, comprising:
a touch display;
one or more processors; and
memory having instructions stored thereon, which when executed by the one or more processors cause the processors to perform operations, comprising instructions to:
display a plurality of data items on a graphical user interface of the touch display;
detect a sequence of finger gestures on the touch display, the sequence of finger gestures further including a finger down gesture immediately followed by a finger moving gesture immediately followed by a finger up gesture;
in accordance with a determination that the sequence of finger gestures satisfy predefined conditions:
identify a set of the plurality of data items as being associated with the sequence of finger gestures; and
display a plurality of operations on the touch display, wherein the plurality of operations are determined at least in part based on an attribute of the identified set of data items.

17. The computing device in claim 16, wherein the attribute of the identified set of the data items comprises whether each data item in the identified set of data items is selected prior to detecting the sequence of finger gestures on the touch display, and displaying the plurality of operations on the touch display further comprises:
for each data item in the identified set of data items associated with the sequence of finger gestures,
determining whether the respective data item is selected prior to detecting the sequence of finger gestures on the touch display;
in accordance with the determination that the respective data item is not selected prior to detecting the sequence of finger gestures on the touch display, selecting the respective data item; and
in accordance with the determination that the respective data item is selected prior to detecting the sequence of finger gestures on the touch display, disabling selection of the respective data item.

18. The computing device in claim 16, wherein after displaying the plurality of operations on the display, at least one data item in the identified set of data items is selected for a subsequent operation that is selected from open, copy, cut, forward, and delete operations.

19. A non-transitory computer readable storage medium storing at least one program configured for execution by at least one processor of a computing device, the computing device comprising a touch display, the at least one program comprising instructions to:
display a plurality of data items on a graphical user interface of the touch display;
detect a sequence of finger gestures on the touch display, the sequence of finger gestures further including a finger down gesture immediately followed by a finger moving gesture immediately followed by a finger up gesture;
in accordance with a determination that the sequence of finger gestures satisfy predefined conditions:
identify a set of the plurality of data items as being associated with the sequence of finger gestures; and
display a plurality of operations on the touch display, wherein the plurality of operations are determined at least in part based on an attribute of the identified set of data items.

20. The computing device in claim 19, wherein after displaying the plurality of operations on the display, at least one data item in the identified set of data items is selected for a subsequent operation that is selected from open, copy, cut, forward, and delete operations.
